(19) United States
(12) Patent Application Publication
(10) Pub. No.: US 2020/0126118 A1
(43) Pub. Date: Apr. 23, 2020

(54) SYSTEMS AND METHODS FOR AUTOMATED AUDIENCE SET IDENTIFICATION

(71) Applicant: Walmart Apollo, LLC, Bentonville, AR (US)

(72) Inventors: Peng Yang, San Jose, CA (US); Sergey Kirshner, Sunnyvale, CA (US); Jayanth Korlimarla, Sunnyvale, CA (US)

(21) Appl. No.: 16/163,294

(22) Filed: Oct. 17, 2018

(51) Int. Cl. G06Q 30/02; G06F 17/18; G06N 99/00

(52) U.S. Cl. CPC G06Q 30/0254; G06F 17/18; G06N 99/005; G06Q 30/0272; G06Q 30/0249; G06Q 30/0255

(57) ABSTRACT

This application relates generally to automated systems and methods to identify an audience set for a marketing campaign period. In an embodiment, a system includes at least one processor operatively coupled with a datastore, the at least one processor configured to receive, from a user device, a request identifying a time period and an item class. The at least one processor is further configured to retrieve, from the datastore, user identifiers based on the time period and the item class. The at least one processor is further configured to determine a conversion value for each of the user identifiers by applying a statistical model to historical transaction data associated with the user identifiers. The at least one processor is further configured to determine an audience set comprising a subset of the user identifiers with the conversion value exceeding a threshold value.

### TECHNICAL FIELD

This application relates generally to automated systems and methods to identify an audience set for a marketing campaign period.

### BACKGROUND

An advertisement may to be a presentation or communication to promote a product or service for purchase. For simplicity of explanation, reference to an item may refer broadly to either a product or a service. A sponsor of an advertisement may typically be a business that seeks to sell the item in the advertisement. Sponsors may seek to more effectively sell their item by employing targeted advertising. As opposed to general advertising that may be indiscriminate, targeted advertising may focus on presenting advertisements to an audience set, which may be a subset of a customer base of all possible customers for the promoted item. A difficulty with targeted advertisement may be the identification of the audience set. Typically, an audience set may be identified in a manual manner, such as from a person (e.g., a member of a marketing team) identifying the places at which a need for the promoted item may be apparent or identifying a characteristic of customers that have purchased the promoted item in the past. These manual identifications of an audience set may be based on a person's experience and/or based on the person's intuition. Accordingly, it may be difficult to determine whether manual identification of an audience set is effective or reproducible due to its manual (e.g., personal) nature. Furthermore, this issue may be compounded when the sponsor of the advertisement is not the party with direct access to the customer base. For example, a retailer may sell many items from many different sources. A sponsor, as one of the sources, may rely upon the retailer to also sell their promoted item, rather than having the sponsor sell their promoted item directly. Therefore, traditional techniques of targeted advertising may not be entirely satisfactory.

The foregoing examples of the related art and limitations related therewith are intended to be illustrative and not exclusive. Other limitations of the related art will become apparent upon a reading of the specification and a study of the drawings.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompanied drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the invention.

In an embodiment, a system includes at least one processor operatively coupled with a datastore. The processor is configured to receive, from a device, a request identifying a time period and an item class. The processor is further configured to retrieve, from the datastore, user identifiers based on the time period and the item class. The processor is further configured to determine a conversion value for each of the user identifiers by applying a statistical model to historical transaction data associated with the user identifiers. The processor is further configured to determine an audience set comprising a subset of the user identifiers with the conversion value exceeding a threshold value.

In an embodiment, a method performed by a computing device includes: receiving a request identifying a time period and an item class. The method also includes retrieving, from a datastore, user identifiers based on the time period and the item class. The method also includes determining a conversion value for each of the user identifiers by applying a statistical model to historical transaction data associated with the user identifiers. The method also includes determining an audience set comprising a subset of the user identifiers with the conversion value exceeding a threshold value.

An embodiment includes a non-transitory computer readable medium having instructions stored thereon. The instructions, when executed by a processor, cause a device to perform operations including: identifying a time period and an item class; retrieving, from a datastore, user identifiers based on the time period and the item class; determining a conversion value for each of the user identifiers by applying a statistical model to historical transaction data associated with the user identifiers; and determining an audience set comprising a subset of the user identifiers with the conversion value exceeding a threshold value.

### BRIEF DESCRIPTION OF THE DRAWINGS

Various exemplary embodiments of the invention are described in detail below with reference to the following Figures. The drawings are provided for purposes of illustration only and merely depict exemplary embodiments of the invention. These drawings are provided to facilitate the reader's understanding of the invention and should not be considered limiting of the breadth, scope, or applicability of the invention. It should be noted that for clarity and ease of illustration these drawings are not necessarily drawn to scale.

FIG. 1 is a system diagram illustrating features of automated audience set identification, in accordance with certain embodiments.

FIG. 2 is a block diagram of an exemplary computing device, in accordance with various embodiments.

FIG. 3A illustrates a data structure of a historical transactions set, in accordance with various embodiments.

FIG. 3B is a training historical transactions set organized with a training feature period and a training label period, in accordance with various embodiments.

FIG. 3C is a campaign transactions set organized with a target feature period and a campaign period, in accordance with various embodiments.

FIG. 3D is a block diagram illustrating a relationship between a training period and a target period, in accordance with various embodiments.

FIG. 4 is a block diagram that illustrates a retailer advertisement process, in accordance with various embodiments.

FIG. 5 is a block diagram that illustrates a conversion value determination process, in accordance with some embodiments.

### DETAILED DESCRIPTION OF EXEMPLARY EMBODIMENTS

Various exemplary embodiments of the invention are described below with reference to the accompanying figures to enable a person of ordinary skill in the art to make and use the invention. As would be apparent to those of ordinary skill in the art, after reading the present disclosure, various changes or modifications to the examples described herein can be made without departing from the scope of the invention. Thus, the present invention is not limited to the exemplary embodiments and applications described and illustrated herein. Additionally, the specific order or hierarchy of steps in the methods disclosed herein are merely exemplary approaches. Based upon design preferences, the specific order or hierarchy of steps of the disclosed methods or processes can be rearranged while remaining within the scope of the present invention. Thus, those of ordinary skill in the art will understand that the methods and techniques disclosed herein present various steps or acts in a sample order, and the invention is not limited to the specific order or hierarchy presented unless expressly stated otherwise.

A new approach is proposed that contemplates systems and methods for automated audience set identification. Automated audience set identification may identify an audience set (e.g., a subset of a customer base) for receipt of advertisements (e.g., promotions for item purchase) during a campaign period in an automated manner. The audience set may be a number of identified customers for which conversion (e.g., purchase of the item) is more likely than customers of the customer base not within the audience set. In certain embodiments, a customer may be a user or discrete entity capable of being associated with a transaction associated with an item. For example, a customer may characterize a user or discrete entity associated with a past, current, or future (e.g., predicted) transaction for an item. Reference to a transaction may be any type of interactions with an item, such as item inspection (e.g., a click through or a view of an electronic advertisement for the item), item browse (e.g., presentation of the item via search results), item add to cart (e.g., an addition of the item to an electronic check out cart), item purchase (e.g., purchase of the item), item advertisement exposure (e.g., previous presentation of the item, such as via an advertisement), item ownership (e.g., previous possession of the item) and the like. This audience set may be identified based on a particular item class (e.g., a class of an item for promotion), campaign period (e.g., a period of time in which the advertisements would be presented to the audience set), and budget value (e.g., an amount of money that the sponsor will pay for presentation of advertisements to the audience set during the campaign period).

Under automated audience set identification, a sponsor of an item for promotion may identify a particular item class, a campaign period, and a budget value. The sponsor, via a user device (e.g., a sponsor user device, or a sponsor device specific to the sponsor), may provide the identified item class, campaign period, and budget value to a retailer advertisement system. The retailer advertisement system may be implemented as, for example, one or more servers in communication with the sponsor user device. The retailer advertisement system may have access to a datastore that includes a historical transactions set that characterizes, substantially, a set of all transactions recorded by a retailer as associated with the retailers retail stores, whether virtual or brick and mortar. These transactions may be represented as transaction data (e.g., historical transaction data). The historical transactions set may be organized by at least item class, customers, and time. As noted above, a retailer may sell many items from many different sources. A sponsor, as one of the sources, may rely upon the retailer to also sell their promoted item, rather than having the sponsor sell their promoted item directly.

The retailer advertisement system may then identify a target customer set based on the item class and the campaign period using the historical transactions set. In particular embodiments, the target customer set may be a subset of a customer base of all customer identifiers (e.g., identified customers or identified users) as identified from the historical transactions set. In certain embodiments, a customer identifier may be a user identifier. A conversion value may be attributed to each of the customer identifiers in the target customer set. This conversion value may reflect a likelihood of conversion, or a likelihood a customer of a customer identifier will purchase an item from the item class identified by the sponsor.

In certain embodiments, the conversion value may be determined from applying a statistical model to historical transaction data associated with the customer. This historical transaction data may be found within the historical transactions set. In certain embodiments, reference to historical transaction data may more simply be referred to as transaction data associated with the past, or past transaction data. The statistical model may be trained on a training period of the historical transactions set and applied to a target period of the historical transactions set. The statistical model may be any type of function from which an input of transaction data may yield an output of a conversion value. For example, the statistical model may be an expression of a regression analysis (e.g., a logistic regression), such as a linear regression, a nonlinear regression, or a multiple regression. The target period may include a period of time (e.g., a target feature period) from which results within the campaign period, as modeled using the statistical model, may be inferred. The training period may include a period of time (e.g., a training feature period) from which results within a training label period (e.g., a historical period of time related to the campaign period), as modeled using the statistical model, may be inferred. The statistical model may be determined (e.g., trained) via a machine learning technique. These machine learning techniques may perform machine learning via for example, supervised learning, unsupervised learning, reinforcement learning, and the like. As a more specific example, these machine learning techniques may be, for example, decision tree learning, association rule learning, artificial neural networks, deep structured learning, inductive logic programming, support vector machines, cluster analysis, Bayesian networks, representation learning, similarity learning, sparse dictionary learning, learning classifier systems, and the like.

Furthermore, based on the budget value, the retailer advertisement system may determine a conversion threshold value. The conversion threshold value may be a threshold value that separates the customer identifiers for inclusion in the audience set from the customer identifiers that are not included in the audience set. For example, the audience set may be made up of customers associated with a conversion value at or above (e.g., at or exceeding) the conversion threshold value. In certain embodiments, the conversion threshold value may be directly related to the budget value, such that a higher budget value may correlate to a higher value for the conversion threshold value. In certain embodiments, a conversion value may be a value between 0 and 1 and the conversion threshold value may also be a value between 0 and 1.

In a variety of embodiments, a conversion threshold value may reflect a range of values. For example, a conversion threshold value may be graded with an overall range of conversion threshold values that are separated into different grades that may be applied for different criteria. These different grades may yet further define members of an audience set. For example, the range of values may be separated into grades, where a higher conversion threshold value may be accorded a first grade and a lower conversion threshold value may be accorded a second grade. Then, for the customers that may fall within the audience set, such customers may be further differentiated between a first grade customer within the audience set or a second grade customer within the audience set. Further to the example, a sponsor may wish to target customers with a higher conversion threshold value (e.g., the first grade customer) for very focused advertising or may wish to target customers with a lower conversion threshold value (e.g., the second grade customer) for less focused advertising that casts a wider net to drive incremental sales.

Accordingly, the audience set may be identified as customer identifiers that meet or pass (e.g., exceed) the conversion threshold value. In certain embodiments, the identified audience set may be passed to an advertising server of the retailer advertisement system that may facilitate the presentation (e.g., allocation) of advertisements to the audience set during the campaign period. For example, the advertisements may be for televisions and the campaign period may be a Christmas holiday period. Accordingly, the advertising platform, based on the audience set identified by the retailer advertisement system, may facilitate the presentation of television advertisements, or specific television advertisements associated with the sponsor, during the Christmas holiday period to the audience set. These advertisements may be, for example, web based advertisements on a website associated with the retailer, on an app (e.g., application on a user device) associated with the sponsor or retailer, in store advertisements presented within a physical (e.g., brick and mortar) retail store, or via other mediums of advertisement presentation. In specific embodiments, the identified audience set may be returned (e.g., via a response message) to the sponsor by being sent from the retailer advertisement system to the sponsor user device associated with the sponsor.

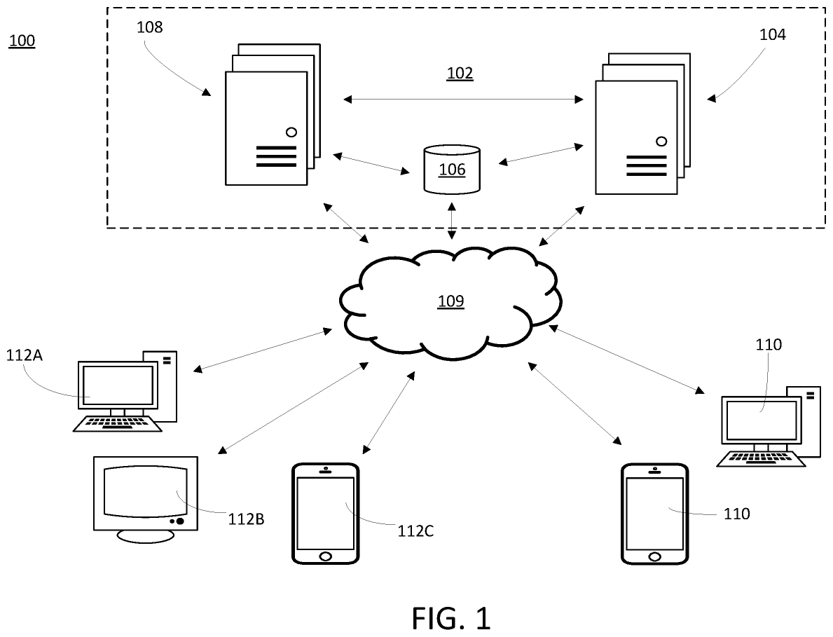

FIG. 1 is a system diagram 100 illustrating features of automated audience set identification, in accordance with certain embodiments. A retailer advertisement system 102 (illustrated within dotted ones) may include an identification server 104 (implemented as one or more servers), a datastore 106, and an advertisement server 108 (implemented as one or more servers). In certain embodiments, each of the functionality of the identification server 104, datastore 106, and advertisement server 108 may be implemented in a single remote server and/or locally on a user device. Each of the identification server 104, the datastore 106, and the advertisement server 108 may be communicatively coupled with each other directly. Also, the retailer advertisement system, in whole or in part, may be communicatively coupled over the network 109 to a variety of user devices. These user devices may include, for example, sponsor user devices 110 and customer user devices 112 (e.g., customer devices).

Sponsor user devices 110 may be user devices utilized by a sponsor to access the retailer advertisement system 102. For example, a sponsor may utilize at least one of the sponsor user devices 110 to communicate the parameters of an advertisement campaign request. These parameters of the advertisement campaign request may be, for example, a particular item class (e.g., a class of an item for promotion), campaign period (e.g., a period of time in which the advertisements would be presented to an audience set), and budget value (e.g., an amount of money that the sponsor will pay for presentation of advertisements to the audience set during the campaign period). This advertisement campaign request may be sent from one of the sponsor user devices 110 to the identification server 104 of the retailer advertisement system 102. The identification server 104 may then determine an audience set, as a subset of a target customer set, based on the item class, campaign period, and budget value. In performing this determination, the identification server 104 may reference transaction data from a historical transactions set stored in the datastore 106.

The audience set may then be communicated to the advertisement server to implement the presentation of advertisements to the audience set during the campaign period. More specifically, the advertisement server may present (e.g., allocate) advertisements on customer user devices 112A, 112B, 112C associated with the audience set during the campaign period. These customer user devices 112A, 112B, 112C may be different types of devices that may present advertisements to the audience set in different contexts.

In certain embodiments, a web page based advertisement may be presented from a customer user device 112A that is a desktop computer or other user device capable of accessing a website on which advertisements may be placed. For example, these advertisements may be placed on a website associated with the retailer or operator of the retailer advertisement system.

In further embodiments, a television or other projection based advertisement may be presented from a customer user device 112B that is a television or a projector. This type of customer user device 112B may be owned by a customer as identified from the audience set. Alternatively, this type of customer user device 112B may be within a physical (e.g., brick and mortar) retail store to which the audience set is known to be at or known to frequent.

In yet further embodiments, a mobile device (e.g., a smartphone or tablet computer) based advertisement may be presented from a customer user device 112C that is a mobile device. This type of advertisement may be placed within an app (e.g., application) associated with the retailer or operator of the retailer advertisement system.

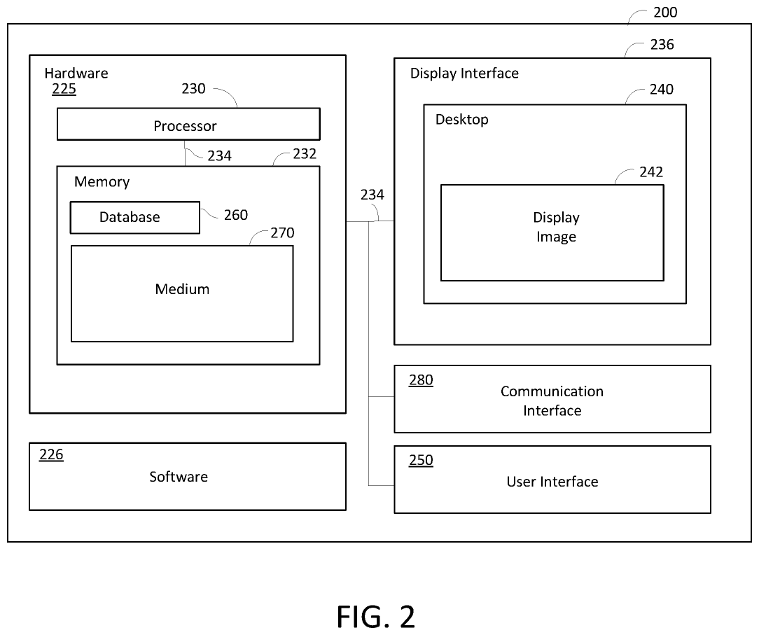

FIG. 2 is a block diagram of an exemplary computing device 200, in accordance with various embodiments. As noted above, the computing device 200 may represent exemplary components of a particular user device (e.g., a customer user device or a sponsor user device) or server (e.g., an identification server or an advertisement server). In some embodiments, the computing device 200 includes a hardware unit 225 and software 226. Software 226 can run on hardware unit 225 (e.g., the processing hardware unit) such that various applications or programs can be executed on hardware unit 225 by way of software 226. In some embodiments, the functions of software 226 can be implemented directly in hardware unit 225 (e.g., as a system-on-a-chip, firmware, field-programmable gate array (“FPGA”), etc.). In some embodiments, hardware unit 225 includes one or more processors, such as processor 230. In some embodiments, processor 230 is an execution unit, or “core,” on a microprocessor chip. In some embodiments, processor 230 may include a processing unit, such as, without limitation, an integrated circuit (“IC”), an ASIC, a microcomputer, a programmable logic controller (“PLC”), and/or any other programmable circuit. Alternatively, processor 230 may include multiple processing units (e.g., in a multi-core configuration). The above examples are exemplary only, and, thus, are not intended to limit in any way the definition and/or meaning of the term “processor.” Hardware unit 225 also includes a system memory 232 that is coupled to processor 230 via a system bus 234. Memory 232 can be a general volatile RAM. For example, hardware unit 225 can include a 32 bit microcomputer with 2 Mbit ROM and 64 Kbit RAM, and/or a number of GB of RAM. Memory 232 can also be a ROM, a network interface (MC), and/or other device(s).

In some embodiments, the system bus 234 may couple each of the various system components together. It should be noted that, as used herein, the term “couple” is not limited to a direct mechanical, communicative, and/or an electrical connection between components, but may also include an indirect mechanical, communicative, and/or electrical connection between two or more components or a coupling that is operative through intermediate elements or spaces. The system bus 234 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, optionally, the computing device 200 can also include at least one media output component or display interface 236 for use in presenting information to a user. Display interface 236 can be any component capable of conveying information to a user and may include, without limitation, a display device (not shown) (e.g., a liquid crystal display (“LCD”), an organic light emitting diode (“OLED”) display, or an audio output device (e.g., a speaker or headphones). In some embodiments, computing device 200 can output at least one desktop, such as desktop 240. Desktop 240 can be an interactive user environment provided by an operating system and/or applications running within computing device 200, and can include at least one screen or display image, such as display image 242. Desktop 240 can also accept input from a user in the form of device inputs, such as keyboard and mouse inputs. In some embodiments, desktop 240 can also accept simulated inputs, such as simulated keyboard and mouse inputs. In addition to user input and/or output, desktop 240 can send and receive device data, such as input and/or output for a FLASH memory device local to the user, or to a local printer.

In some embodiments, the computing device 200 includes an input or a user interface 250 for receiving input from a user. User interface 250 may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of the media output component and the input interface. In some embodiments, mobile devices, such as tablets, can be used.

In some embodiments, the computing device 200 can include a database 260 within memory 232, such that various information can be stored within database 260. Alternatively, in some embodiments, database 260 can be included within a remote datastore (not shown) or a remote server (not shown) with file sharing capabilities, such that database 260 can be accessed by computing device 200 and/or remote end users. In some embodiments, a plurality of computer-executable instructions can be stored in memory 232, such as one or more computer-readable storage medium 270 (only one being shown in FIG. 2). Computer-readable storage medium 270 includes non-transitory media and may include volatile and nonvolatile, removable and non-removable mediums implemented in any method or technology for storage of information such as computer-readable instructions, data structures, program modules or other data. The instructions may be executed by processor 230 to perform various functions described herein.

In the example of FIG. 2, the computing device 200 can be a communication device, a storage device, or any device capable of running a software component. For non-limiting examples, the computing device 200 can be but is not limited to a server machine, smartphone, a laptop PC, a desktop PC, a tablet, a Google's Android device, an iPhone, an iPad, and a voice-controlled speaker or controller.

The computing device 200 has a communications interface 280, which enables the computing devices to communicate with each other, the user, and other devices over one or more communication networks following certain communication protocols, such as TCP/IP, http, https, ftp, and sftp protocols. Here, the communication networks can be but are not limited to, the Internet, an intranet, a wide area network (WAN), a local area network (LAN), a wireless network, Bluetooth, WiFi, and a mobile communication network.

In some embodiments, the communications interface 280 may include any suitable hardware, software, or combination of hardware and software that is capable of coupling the computing device 200 to one or more networks and/or additional devices. The communications interface 280 may be arranged to operate with any suitable technique for controlling information signals using a desired set of communications protocols, services or operating procedures. The communications interface 280 may comprise the appropriate physical connectors to connect with a corresponding communications medium, whether wired or wireless.

A network may be utilized as a vehicle of communication. In various aspects, the network may comprise local area networks (LAN) as well as wide area networks (WAN) including without limitation the Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 280 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 280 may comprise a wireless interface comprising one or more antennas, transmitters, receivers, transceivers, amplifiers, filters, control logic, and so forth.

In various aspects, the communications interface 280 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

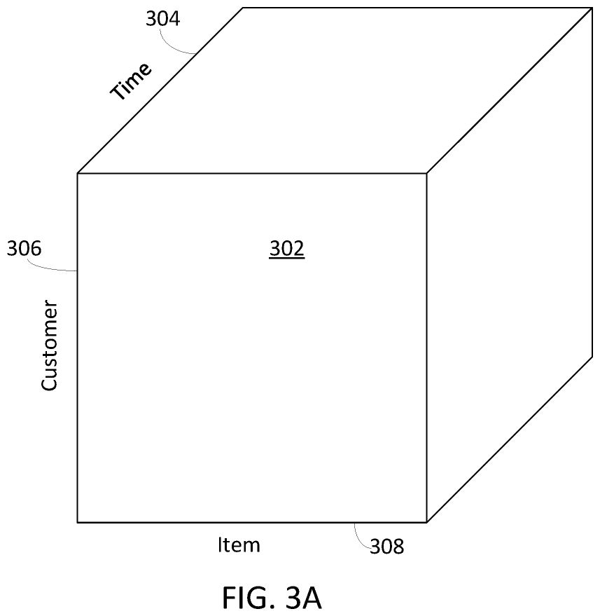

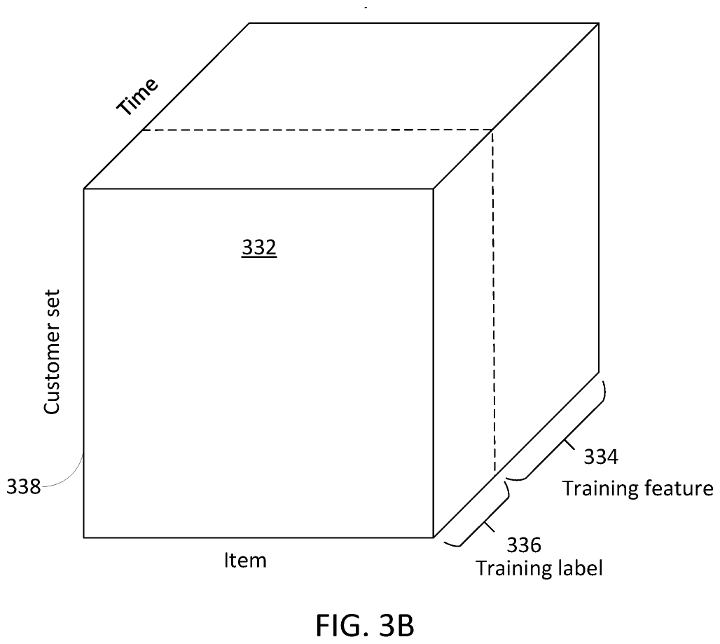

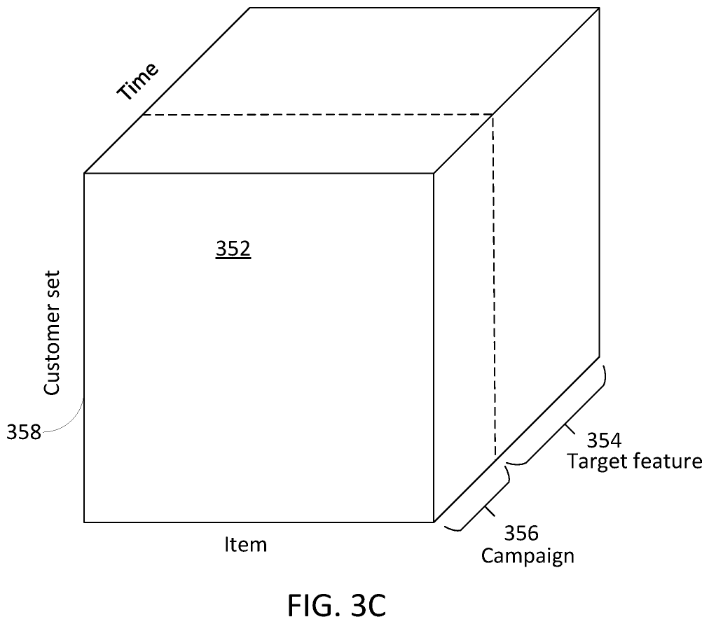

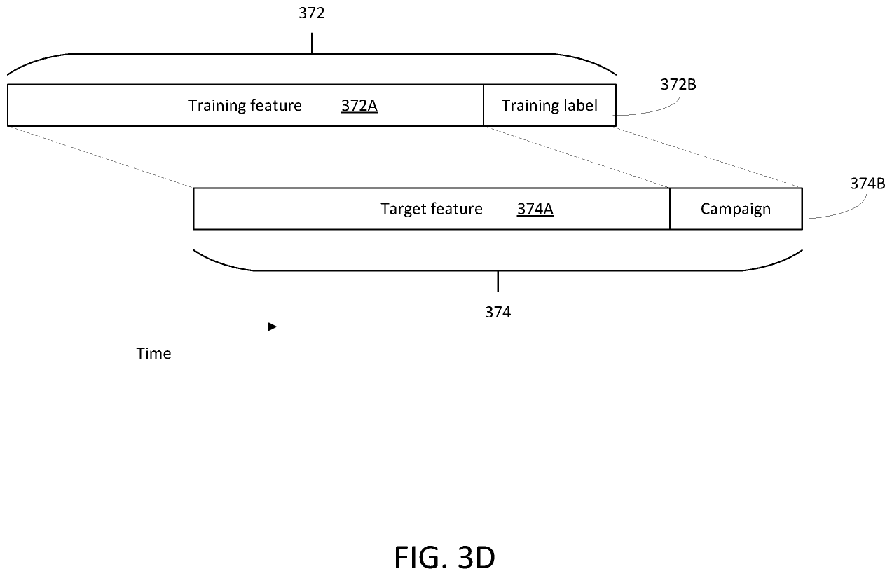

FIG. 3A illustrates a data structure of a historical transactions set 302, in accordance with various embodiments. As noted above, the historical transactions set may be stored in a datastore accessible to an identification server. The historical transactions set 302 may be a structured data set of historical transaction data ordered by a time axis 304, a customer identifier axis 306, and item class axis 308. Stated another way, the historical transactions set may be a structured data set ordered by time, customer identifiers, and item classes. The item classes may be any type of unique classes for each item sold or offered to sale by a retailer, such as televisions, microwaves, tables, potato chips, and the like. The item classes may be at an arbitrary level of granularity, as dependent upon the granularity at which each of the transactions (as associated with transaction data) are recorded. Also, the customer identifiers may be any type of identifier of a particular customer, such as a customer name, account number, credit card number, address, telephone number, and the like. The totality of the customer identifiers in the historical transactions set may be referred to as a customer base. Stated another way, a customer base may be an aggregation of all customers identifiable from the historical transactions set. As will be discussed further below, this customer base may be different than the customer identifiers (e.g., customers identified) in a training customer set, target customer set, or an audience set.

In certain embodiments, the transaction data associated with each transaction may have an associated time, customer identifier, and item class that are each expressed in a uniform way across each of the transactions in the historical transactions set 302. For example, the expression of time for transaction data may be with a year, month, and day. As another example, the expression of customer identifier may be a customer account number. As yet another example, the expression of item class may be chosen from a predetermined set number of item classes that every item sold or sellable by the retailer may be classified in.

For example, a retailer may keep a record of each transaction (e.g., each interaction with an item online or in a physical store) that the retailer may have undergone as transaction data. Accordingly, this transaction data may cover some sort of sale, such as a sale of a television, a refrigerator, a chair, or other item. The transaction data of each transaction may have an associated time, customer (e.g., as organized by a customer identifier), and item class (e.g., potato chips, produce, televisions, electronics, or any other category capable of classifying an item at any level of granularity). With aggregation, the records of these transactions as transaction data may begin to form a historical transactions set, which includes transaction data that is structured in accordance with time, customer identifier, and item class.

As noted above, an identification server may identify a target customer set and/or a training customer set based on the historical transactions set 302. The identification server may identify the target customer set and/or a training customer set based on a campaign period and a specific item class, as provided by a sponsor user device. In certain embodiments, reference to an item class received from a sponsor user device may refer to one or more item classes received from the sponsor user device. As noted above, historical transaction data may be organized by time, customer identifier, and item class. Thus, a target customer set and/or a training customer set may be identified by looking up the customer identifiers corresponding to a time period associated with a campaign period and an item class in the historical transactions set. Similarly, specific times and item classes may be found when looking up specific customer identifiers in the historical transactions set.

In certain embodiments, a campaign period may identify a future period of time without transaction data within the historical transactions set. Therefore, aspects of customer identifiers and/or item classes for that future period of time may be projected, or predicted based on a statistical model applied to historical transaction data associated with certain customer identifiers. These customer identifiers may be associated with historical transaction data that may be deemed as relevant to a projected future transaction (e.g., purchase) of an item within a specific item class.

In certain embodiments, a training label period may be a time period associated with (e.g., due to correspondence or being analogous to) a campaign period. The training label period may be a period of time within a historical transactions set. A training feature period may be a period of time in which a statistical model may be applied to transaction data of the training feature period to predict resulting transaction data (e.g., whether a transaction, or a sale, has occurred) in the training label period. The statistical model may be determined in accordance with any type of machine learning technique to predict the resulting transaction data in the training label period. These machine learning techniques may be, for example, decision tree learning, association rule learning, artificial neural networks, deep structured learning, inductive logic programming, support vector machines, cluster analysis, Bayesian networks, representation learning, similarity learning, sparse dictionary learning, learning classifier systems, and the like.

Similarly, the campaign period may be a future period of time outside of the historical transactions set. A target feature period may be a period of time of the historical transactions set in which the statistical model, trained in the training feature period, may be applied to transaction data in the target feature period to predict resulting transaction data that will occur in the campaign period.

In various embodiments, a campaign period may be either periodic or nonperiodic. A periodic campaign period may be a campaign period which is seasonal or repeats itself on a regular basis. An example of a periodic campaign period is a campaign period related to a seasonal event, such as a birthday, a Christmas holiday period, a thanksgiving holiday period, an Easter holiday period, and the like. A target feature period of a periodic campaign period may be an arbitrary set amount of time that leads up to the campaign period. For example, the target feature period of the periodic campaign period may be a span of a full year immediately prior to the campaign period. Also, a periodic campaign period may have an associated training label period at a corresponding historical period of time. For example, a periodic campaign period for an upcoming Christmas holiday season may have an associated training label period of the immediately past (e.g., last year's) Christmas holiday season. Furthermore, a training feature period of a periodic campaign period may be an arbitrary set amount of time that leads up to the training label period. For example, the training feature period of the periodic campaign period may be a span of a full year immediately prior to the training label period. As another example, if the campaign period for a Christmas holiday season is December 2018, then the training label period may be December 2017. Also, the training feature period may be from July 2016 to November 2017 and the target feature period may be from July 2017 to November 2018.

On the other hand, a nonperiodic campaign period may be a campaign period that is not seasonal (e.g., non-seasonal) or that does not repeat itself on a regular basis. An example of a nonperiodic campaign period may be a set arbitrary period of time, such as an upcoming month. A target feature period of a nonperiodic campaign period may be an arbitrary set amount of time that leads up to the campaign period. For example, the target feature period of the nonperiodic campaign period may be a span of a full year immediately prior to the campaign period. Also, a nonperiodic campaign period may have an associated training label period at an arbitrary period of time with some kind of correlation to the campaign period. For example, the associated training label period of a nonperiodic campaign period may be an immediately past month. Furthermore, a training feature period of a nonperiodic campaign period may be an arbitrary set amount of time that leads up to the training label period. For example, the training feature period of the nonperiodic campaign period may be a span of a full year immediately prior to the training label period. As another example, if the nonperiodic campaign period is December 2018, then the training label period may be November 2018. Also, the training feature period may be from April 2017 to October 2018 and the target feature period may be from May 2017 to November 2018.

FIG. 3B is a training historical transactions set 332 organized with a training feature period 334 and a training label period 336, in accordance with various embodiments. The training historical transactions set 332 may be a subset of the historical transactions set, discussed above. More specifically, the training historical transactions set 332 may only include customer identifiers of a training customer set 338, which may be a subset of a customer base. This training customer set may include any customer identifiers with transaction data from transactions within a time period associated with the training label period 336 and/or the training feature period 334

As noted above, the training feature period 334 is a period of time in which a statistical model, under training, may be applied to transaction data in the training feature period 334 to predict resulting transaction data in the training label period 336. These predictions may be a probability of whether the resulting transaction data in the training label period 336 is indicative of a purchase of an item within a particular item class. The statistical model may be determined in accordance with any type of machine learning technique applicable to the training feature period 334 to predict outcomes (e.g., resulting transaction data) in the training label period 336. This transaction data may be associated with customers of a training customer set, which may be a subset of a customer base.

FIG. 3C is a campaign transactions set 352 organized with a target feature period 354 and a campaign period 356, in accordance with various embodiments. The campaign transactions set 352 may include a subset of the historical transactions set, discussed above. For example, the campaign transactions set 352 may include customer identifiers of a target customer set 358, which may be a subset of a customer base. This target customer set 358 may include customer identifiers with transaction data from transactions within a time period associated with the target feature period 354. Also, the transaction data in the target feature period 354 may overlap with corresponding transaction data in a historical transactions set. However, the transaction data within the campaign period 356 may represent predicted transaction data based on the application of a statistical model to the transaction data in the target feature period 354 and not overlap with transaction data in a historical transactions set.

As noted above, the target feature period 354 is a period of time in which the statistical model may be applied to transaction data in the target feature period 354 to predict resulting transaction data in the campaign period 356. These predictions may result in a probability or likelihood of whether the resulting transaction data in the campaign period 356 is indicative of a purchase of an item within a particular item class. The statistical model may be determined in accordance with any type of machine learning technique that may be trained in the training feature period, as discussed above.

As discussed above, in various embodiments, the customer identifiers of the campaign transactions set 352 may be the same the customer identifiers of a training customer set of the training historical transactions set discussed above. Stated another way, in various embodiments, the training customer set and the target customer set may be the same.

However, in other embodiments, the customer identifiers of the campaign transactions set 352 may be an entire customer base. Stated another way, in other embodiments, a training customer set and a target customer set may be different and/or the target customer set may be the same as a customer base. Therefore, when the target customer set is the same as a customer base, the statistical model trained using the training historical transactions set may be applied to the entire customer base to determine conversion values for each of the customer identifiers in the entire customer base. Then, the audience set may be determined from analyzing the entire customer base of all customers within a historical transactions set.

FIG. 3D is a block diagram illustrating a relationship between a training period 372 and a target period 374, in accordance with various embodiments. The training period 372 may be a period of time inclusive of a training feature period 372A and a training label period 372B. As noted above, the training feature period 372A is a period of time in which a statistical model, under training, may be applied to transaction data in the training feature period 372A to predict resulting transaction data in the training label period 372B. Also, the target period 374 may be a period of time inclusive of a target feature period 374A and a campaign period 374B. As noted above, the target feature period 374A is a period of time in which the statistical model trained in training period 372 may be applied to transaction data in the target feature period 374A to predict resulting transaction data in the campaign period 374B.

Furthermore, as noted above, a sponsor (via a sponsor user device) may identify the campaign period 374B along with an item class and budget value for a retailer advertisement system, and more specifically an identification server, to identify an audience set. Accordingly, the identification server may identify a training customer set from a customer base for inclusion in a training historical transactions set spanning the training period 372. This training customer set may be looked up based on customer data in a historical transactions set that organizes customer data in accordance with time, item class, and customer identifier. Also, a statistical model may be trained using the training feature period 372A in view of outcomes (e.g., results) in the training label period 372B. More specifically, the statistical model may take as input the transaction data in the training feature period 372A and produce as output a likelihood of a particular outcome (e.g., particular transaction data) in the training label period. Then, the trained statistical model may be applied to transaction data in the target feature period 374A to produce as output a likelihood of a particular outcome in the campaign period 374B. This likelihood of a particular outcome may be a conversion value, as discussed further below.

Also, as will be discussed further below, this likelihood of a particular outcome in the campaign period may be associated with a particular customer identifier and compared against a conversion threshold value to determine an audience set. More specifically, in certain embodiments, a customer identifier is included in the audience set when a likelihood of a particular outcome in the campaign period associated with the customer identifier meets or exceeds the conversion threshold value. Then, an advertising server of the retailer advertisement system may cause (e.g., schedule) advertisements to be presented to the customer identifiers in the audience set via customer user devices.

Also, as noted above, the campaign period 374B may be either periodic or nonperiodic. When periodic, the campaign period 374B may be a campaign period which is seasonal or has a well-defined corresponding training label period 372B. An example of a periodic campaign period is a campaign period 374B related to a seasonal event, such as a birthday, a Christmas holiday period, a thanksgiving holiday period, an Easter holiday period, and the like. A target feature period 374A of a periodic campaign period 374B may be an arbitrary set amount of time that leads up to the campaign period 374B. For example, the target feature period 374A of the periodic campaign period 374B may be a span of a full year immediately prior to the campaign period 374B. Accordingly, the periodic campaign period 374B may have an associated training label period 372B at a corresponding historical period of time. For example, a periodic campaign period 374B for an upcoming Christmas holiday season may have an associated training label period 372B of the immediately past (e.g., last year's) Christmas holiday season. Furthermore, a training feature period 372A may be an arbitrary set amount of time that leads up to the training label period 372B. For example, the training feature period 372A of the periodic campaign period may be a span of a full year immediately prior to the training label period 372B.

On the other hand, when nonperiodic, the campaign period 374B may not be seasonal or may not have corresponding repeats of itself on a regular basis. An example of a nonperiodic campaign period 374B may be a set period of time, such as an upcoming month. A target feature period 374A of a nonperiodic campaign period 374B may be an arbitrary set amount of time that leads up to the campaign period 374B. For example, the target feature period 374A of the nonperiodic campaign period 374B may be a span of a full year immediately prior to the campaign period 374B. Also, a nonperiodic campaign period 374B may have an associated training label period 372B at an arbitrary period of time with some kind of correlation to the campaign period 374B. For example, the associated training label period 372B may be an immediate past month. Furthermore, a training feature period 372A of a may be an arbitrary set amount of time that leads up to the training label period 372B. For example, the training feature period 372A of the nonperiodic campaign period may be a span of a full year immediately prior to the training label period 372B.

In certain embodiments, the target feature period 374A may share a same time as that of the training label period 372B and part of the training feature period 372A. However, in other embodiments, the target feature period 374A may overlap only with the training feature period 372A and not the training label period 372B. In yet further embodiments, the target feature period 374A may overlap only with the training label period 372B and not the training feature period 372A. In further yet embodiments, the target feature period 374A may not overlap with either of the training feature period 372A or the training label period 372B.

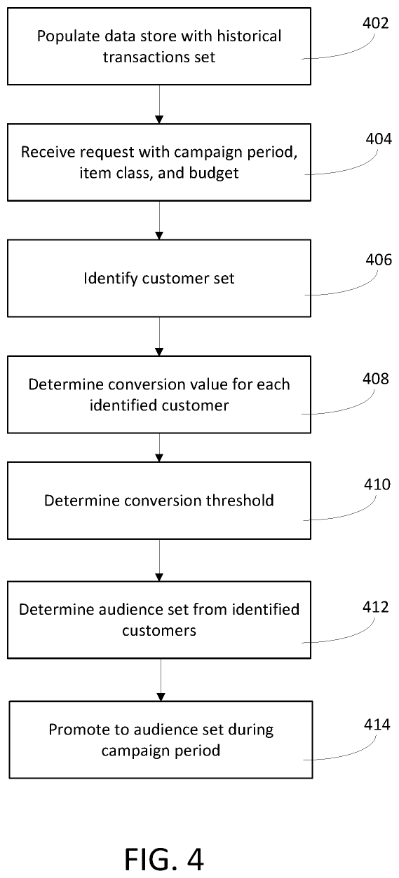

FIG. 4 is a block diagram that illustrates a retailer advertisement process 400, in accordance with various embodiments. The process 400 may be performed at a retailer advertisement system in communication with a sponsor user device or a customer user device, as introduced above. The retailer advertisement system may include a datastore, an identification server implemented as at least one server, and an advertisement server implemented as at least one server. In certain embodiments, the retailer advertisement system may be implemented as a single server or within a single housing. It is noted that the process 400 is merely an example, and is not intended to limit the present disclosure. Accordingly, it is understood that additional operations may be provided before, during, and after the process 400 of FIG. 4, certain operations may be omitted, certain operations may be performed concurrently with other operations, and that some other operations may only be briefly described herein.

At block 402, a historical transactions set may be stored at a datastore of the retailer advertisement system. The historical transactions set may be produced or stored by populating the datastore with transaction data. This transaction data may be from transactions at a retailer's store, whether virtual or physical (e.g., brick and mortar), as recorded by a retailer or operator of the retailer advertisement system. More specifically, the transaction data that constitutes the historical transactions set may include at least a time, an item class, and customer identifier. Each of these transactions may be, for example, a sale transaction of a time (e.g., a time of sale), item class (e.g., classification of the item sold), and customer identifier (e.g., an identifier of a customer that bought the item).

In certain embodiments, the historical transactions set may be a structured data set ordered by time, customer identifiers, and item classes. The item classes may be any type of unique classes for each item sold or offered to sale by a retailer, such as televisions, microwaves, tables, potato chips, and the like. The item classes may be at an arbitrary level of granularity, as dependent upon the granularity at which each of the transactions (as associated with transaction data) are recorded. Also, the customer identifiers may be any type of identifier of a particular customer, such as a customer name, account number, credit card number, address, telephone number, and the like. The totality or aggregation of the customer identifiers in the historical transactions set may be referred to as a customer base. This customer base may be different than a training customer set or a target customer set. Also, this customer base may be different than an audience set (which may be a subset of the target customer set).

At block 404, the identification server of the retailer advertisement system may receive an advertisement campaign request from a sponsor user device. The sponsor user device may be a user device associated with a sponsor (e.g., as associated with a sponsor account or other type of account or identifier associated with the sponsor). The sponsor user device, via for example, an app on the sponsor user device, may send the advertisement campaign request to the identification server. The advertisement campaign request may include at least a campaign period, an item class, and a budget value. In certain embodiments, the advertisement campaign request may include multiple requests for different advertisement campaigns, such as a request for different campaign periods associated with different respective item classes and budget values. In various embodiments, a single advertisement campaign request may include a single campaign period that is discontinuous (e.g., not within a continuous time frame) and/or may include multiple item classes (e.g., where an item may fall under or be associated with multiple item classes).

At block 406, a training customer set and a target customer set may be identified by the identification server based on the advertisement campaign request. More specifically, the training customer set and the target customer set may be identified based on the campaign period and item class associated with the advertisement campaign request. As noted above, historical transaction data may be organized by time, customer identifier, and item class. Thus, the training customer set and the target customer set may be identified by looking up, in the historical transactions set, the customer identifiers corresponding to both a time period associated with a campaign period and an item class identified by the advertisement campaign request. Similarly, specific times and item classes may be found when looking up specific customer identifiers in the historical transactions set.

As noted above, the customer base may include all customer identifiers of the historical transaction data. Also, the training customer set may include any customer identifiers with transaction data from transactions associated with an item class identified by the advertisement campaign request and within a time period associated with a training label period and/or a training feature period. Furthermore, the target customer set may include any customer identifiers with transaction data from transactions associated with an item class identified by the advertisement campaign request and within a time period associated with a target feature period. In certain embodiments, the training customer set and the target customer set may be the same. In other embodiments, the training customer set and the target customer set may be different. In yet other embodiments, the target customer set may be the same as the customer base.

Each of the training label period, the training feature period, and the target feature period may be identified by the campaign period identified by the advertisement campaign request. For example, the training label period may be identified from a campaign period as an associated or corresponding time period to the campaign period.

As noted above, a campaign period may be either periodic or nonperiodic. A periodic campaign period may be a campaign period which is seasonal or repeats itself on a regular basis. An example of a periodic campaign period is a campaign period related to a seasonal event, such as a birthday, a Christmas holiday period, a thanksgiving holiday period, an Easter holiday period, and the like. A target feature period of a periodic campaign period may be an arbitrary set amount of time that leads up to the campaign period. For example, the target feature period of the periodic campaign period may be a span of a full year immediately prior to the campaign period. Also, a periodic campaign period may have an associated training label period at a corresponding historical period of time. For example, a periodic campaign period for an upcoming Christmas holiday season may have an associated training label period of the immediately past (e.g., last year's) Christmas holiday season. Furthermore, a training feature period of a periodic campaign period may be an arbitrary set amount of time that leads up to the training label period. For example, the training feature period of the periodic campaign period may be a span of a full year immediately prior to the training label period. As another example, if the campaign period for a Christmas holiday season is December 2018, then the training label period may be December 2017. Also, the training feature period may be from July 2016 to November 2017 and the target feature period may be from July 2017 to November 2018.

On the other hand, a nonperiodic campaign period may be a campaign period that is not seasonal (e.g., non-seasonal) or that does not repeat itself on a regular basis. An example of a nonperiodic campaign period may be a set arbitrary period of time, such as an upcoming month. A target feature period of a nonperiodic campaign period may be an arbitrary set amount of time that leads up to the campaign period. For example, the target feature period of the nonperiodic campaign period may be a span of a full year immediately prior to the campaign period. Also, a nonperiodic campaign period may have an associated training label period at an arbitrary period of time with some kind of correlation to the campaign period. For example, the associated training label period of a nonperiodic campaign period may be an immediately past month. Furthermore, a training feature period of a nonperiodic campaign period may be an arbitrary set amount of time that leads up to the training label period. For example, the training feature period of the nonperiodic campaign period may be a span of a full year immediately prior to the training label period. As another example, if the nonperiodic campaign period is December 2018, then the training label period may be November 2018. Also, the training feature period may be from April 2017 to October 2018 and the target feature period may be from May 2017 to November 2018.

In numerous embodiments, each of the training feature period and the target feature period may be determined based on the item class provided in the advertisement campaign request. In various optional embodiments, each of the training feature period and the target feature period may be determined based on the budget value provided in the advertisement campaign request. For example, a larger budget value may correspond to a longer training feature period and/or a longer target feature period. Also, a smaller budget value may correspond to a shorter training feature period and/or a shorter target feature period.

At block 408, at the identification server, a conversion value may be determined and associated with each of the customer identifiers of the target customer set. The conversion value may represent the likelihood of a sale of an item within the item class identified by the advertisement campaign request within the campaign period.

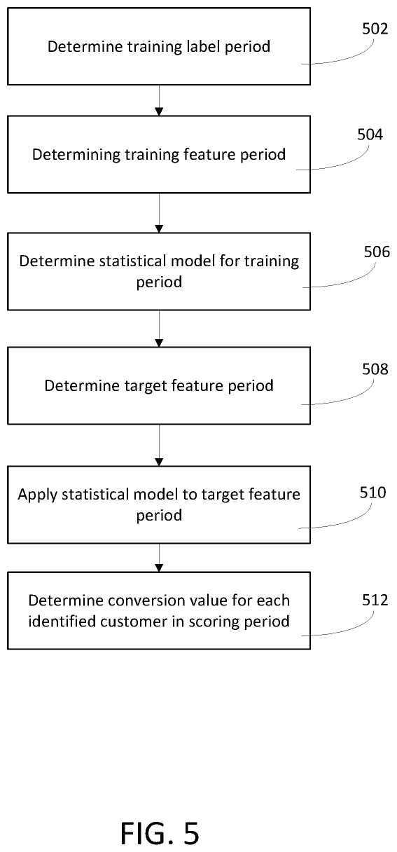

As noted above, a statistical model may be trained using a training feature period in view of outcomes (e.g., results) in a training label period. More specifically, the statistical model may take as input the transaction data in the training feature period and produce as output a likelihood of a particular outcome (e.g., the presence of transaction data) in the training label period. Then, the trained statistical model may be applied to transaction data in a target feature period to produce as output a likelihood of a particular result (e.g., a sale of an item in an identified item class) in the campaign period. This likelihood may be a conversion value. Also, each instance of the transaction data on which the training statistical model was applied may have an associated customer identifier. Accordingly, each customer identifier may have an associated conversion value. Further discussion of conversion value determination is discussed below in connection with FIG. 5.

At block 410, a conversion threshold value may be determined at the identification server. The conversion threshold value may be a threshold value that separates the customer identifiers for inclusion in the audience set from the customer identifiers that are not included in the audience set. For example, the audience set may be made up of customer identifiers associated with a conversion value at or above the conversion threshold value.

Furthermore, the conversion threshold value may be based on the budget value provided in the advertisement campaign request. For example, the conversion threshold value may be directly related to the budget value, such that a higher budget value may correlate to a higher value for the conversion threshold value. In certain embodiments, each conversion value may be a value between 0 and 1 and the conversion threshold value may also be a value between 0 and 1.

As noted above, in a variety of embodiments, a conversion threshold value may reflect a range of values. For example, a conversion threshold value may be graded with an overall range of conversion threshold values that are separated into different grades that may be applied for different criteria. In particular embodiments, the distinction between the different grades may be based on the budget value. For example, more grades may be provided with a higher budget value and/or the grades may be more narrow with a higher budget value. Accordingly, these different grades may yet further define members of an audience set. For example, the range of values may be separated into grades, where a higher conversion threshold value may be accorded a first grade and a lower conversion threshold value may be accorded a second grade. Then, for the customers that may fall within the audience set, such customers may be further differentiated between a first grade customer within the audience set or a second grade customer within the audience set. Further to the example, a sponsor may wish to target customers with a higher conversion threshold value (e.g., the first grade customer) for very focused advertising or may wish to target customers with a lower conversion threshold value (e.g., the second grade customer) for less focused advertising that casts a wider net to drive incremental sales.

At block 412, each of the customer identifiers of the target customer set may be assessed against the conversion threshold value. As noted above, the conversion threshold value may be a threshold value that separates the customer identifiers for inclusion in the audience set from the customer identifiers that are not included in the audience set. For example, the audience set may be made up of customer identifiers associated with a conversion value at or above the conversion threshold value. Accordingly, each customer identifier that is associated with a conversion value at or above the conversion threshold value is included within the audience set. Also, each customer identifier that is not associated with a conversion value at or above the conversion threshold is not included within the audience set. Stated another way, the audience set may be a set of customers, identified by their customer identifier, whose likelihood of purchase (e.g., conversion) of an item in an item class may be greater than a conversion threshold value.

At block 414, the advertisement server of the retailer advertisement system may promote or present advertisements to the audience set during the campaign period identified in the advertisement campaign request. The audience set may be passed (e.g., communicated) from the identification server to an advertisement server of the retailer advertisement system. The audience set may be communicated via a network (e.g., the Internet) or via a wired or wireless connection of a local network within the context of the retailer advertisement system. Then, the advertising server of the retailer advertisement system may cause (e.g., schedule) advertisements to be presented to the customer identifiers in the audience set via customer user devices.

For example, the advertisements may be for televisions and the campaign period may be a Christmas holiday period. Accordingly, the advertising platform, based on the audience set identified by the retailer advertisement system, may facilitate the presentation of television advertisements, or specific television advertisements associated with the sponsor, during the Christmas holiday period to the audience set. These advertisements may be, for example, web based advertisements on a website associated with the retailer, on an app (e.g., application on a user device) associated with the sponsor or retailer, in store advertisements presented within a physical retail store, or via other mediums of advertisement presentation. In various embodiments, the extent and/or type of the advertisements may also be based on the budget value provided in the advertisement campaign request.

FIG. 5 is a block diagram that illustrates a conversion value determination process 500, in accordance with some embodiments. The process 500 may be performed at a retailer advertisement system that may include a datastore and an identification server implemented as at least one server. It is noted that the process 500 is merely an example, and is not intended to limit the present disclosure. Accordingly, it is understood that additional operations may be provided before, during, and after the process 500 of FIG. 5, certain operations may be omitted, certain operations may be performed concurrently with other operations, and that some other operations may only be briefly described herein.

At block 502, a training label period may be determined by the identification server based on the campaign period provided by the advertisement campaign request. The training label period may be an analogous or corresponding period of time to the campaign period.

In certain embodiments, when the campaign period is periodic, for example an upcoming Christmas holiday season, the training label period may be an analogous past Christmas holiday season, such as the Christmas holiday season of last year. The exact extent of what constitutes the exact time of the campaign period, even when periodic, may be set by an operator (e.g., a sponsor or a retailer) so that an analogous past campaign period may be readily determinable. For example, a training label period for a Christmas holiday season may span the same number of days and in the same orientation (e.g., number of days prior to and after) with Christmas as the Christmas holiday season identified for the campaign period.

In particular embodiments, the campaign period may be nonperiodic. By being nonperiodic, the training label period may be taken as an arbitrary but analogous period of time in which there is historical transaction data. For example, if the campaign period is next month, the training label period may be determined to be the past month.

In various embodiments, the campaign period may encompass multiple discrete periods of time. Accordingly, the identification server may also identify the training label period also as multiple discrete periods of time analogous or corresponding to the campaign period. These individual discrete training label periods may be identified in a similar manner to how a continuous training label period is determined for a campaign period that is a continuous period of time.

At block 504, a training feature period may be identified by the identification server. The training feature period may be a period of time leading up to (e.g., prior) to the training label period and within which a statistical model may be trained to predict outcomes (e.g., recorded transaction data) within the training label period. The training feature period may be of an arbitrary length of time. For example, the training feature period may be a period of one year or a few months prior to the training label period. In certain embodiments, the length of the training feature period may be based on a budget value provided in the advertisement campaign request. For example, the training label period may be larger with a larger budget value. Also, in certain embodiments, the training feature period may be continuous with the training label period, such as where the training feature period ends when the training label period begins. However, in other embodiments, the training feature period may not continuous with the training label period, such as where the training feature period ends not where the training label period begins.

In various embodiments, the training label period may encompass multiple discrete periods of time. Accordingly, the identification server may also identify the training feature period as one or more periods of time that corresponds, or leads up, to the training label period that encompasses multiple discrete periods of time

At block 506, a statistical model may be determined or trained by the identification server. This statistical model may predict whether there will be transaction data (e.g., a sale, or a transaction) within the training label period based on the transaction data in the training feature period. Stated another way, the statistical model may be trained using the data in the training feature period to predict outcomes in the training label period. These outcomes may be binary (e.g., whether or not there will be transaction data associated with a transaction, or a sale, during the training label period). This training may be produced using machine learning techniques. These machine learning techniques may be, for example, decision tree learning, association rule learning, artificial neural networks, deep structured learning, inductive logic programming, support vector machines, cluster analysis, Bayesian networks, representation learning, similarity learning, sparse dictionary learning, learning classifier systems, and the like.

At block 508, a target feature period may be determined by the identification server. The target feature period may be a period of time leading up to (e.g., prior) to the campaign period and within which a statistical model may be applied to predict outcomes (e.g., recorded transaction data) within the campaign period. The target feature period may be of an arbitrary length of time. For example, the target feature period may be a period of one year or a few months prior to the campaign period. In various embodiments, the target feature period may be of a same length of time as the training feature period. However, in other embodiments, the target feature period may be of a different length of time than the training feature period.

In certain embodiments, the length of the target feature period and/or training feature period may be based on an item class provided in the advertisement campaign request. For example, the target feature period and/or training feature period may be larger with certain item classes and smaller with other item classes.

Also, in certain embodiments, the target feature period may be continuous with the campaign period, such as where the target feature period ends when the campaign period begins. However, in other embodiments, the target feature period may not continuous with the campaign period, such as where the target feature period ends not where the campaign period begins.

In various embodiments, the campaign period may encompass multiple discrete periods of time. Accordingly, the identification server may also identify the target feature period as one or more periods of time that corresponds, or leads up, to the campaign period that encompasses multiple discrete periods of time.

At block 510, the identification server may apply the trained statistical model to the transaction data in the target feature period to determine a conversion value. The conversion value may express a likelihood of a transaction (e.g., a purchase) within the campaign period. More specifically, by being applied to the target feature period, the trained statistical model may take as input the transaction data within the target feature period (e.g., transaction data associated with a customer identifier and indicative of at least a transaction time and an item class) and produce an output characterizing a likelihood of a transaction (e.g., a purchase) within the campaign period. In certain embodiments, this likelihood may be expressed as a value between 0 and 1 but any expression of likelihood may be utilized as desired in various applications in numerous embodiments. For example, the likelihood may be expressed as an integer value or as a percentage.

At block 512, the identification server may associate the determined conversion value with a corresponding customer identifier. This corresponding, or associated, customer identifier may be the customer identifier associated with the transaction data utilized to produce the conversion value. In certain embodiments, the identification server may also rank the customer identifiers associated with transaction data in the target feature period from greatest conversion value (e.g., greatest likelihood of a transaction, or a purchase, within the campaign period) to least conversion value (e.g., lowest likelihood of a transaction, or a purchase, with in the campaign period). As discussed above, the identification server may determine an audience set based on a comparison between respective conversion values of customer identifiers with a conversion threshold value.

While various embodiments of the invention have been described above, it should be understood that they have been presented by way of example only, and not by way of limitation. Likewise, the various diagrams may depict an example architectural or configuration, which are provided to enable persons of ordinary skill in the art to understand exemplary features and functions of the invention. Such persons would understand, however, that the invention is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two, which can be designed using source coding or some other technique), various forms of program or design code incorporating instructions (which can be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware, firmware or software, or a combination of these technique, depends upon the particular application and design constraints imposed on the overall system. Skilled artisans can implement the described functionality in various ways for each particular application, but such implementation decisions should not be interpreted as causing a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A system, comprising:
at least one processor operatively coupled with a datastore, the at least one processor configured to:
receive, from a device, a request identifying a time period and an item class;
retrieve, from the datastore, user identifiers based on the time period and the item class;
determine a conversion value for each of the user identifiers by applying a statistical model to historical transaction data associated with the user identifiers; and
determine an audience set comprising a subset of the user identifiers with the conversion value exceeding a threshold value.

2. The system of claim 1, wherein the at least one processor is configured to:
identify the threshold value based on a budget value received from the device.

3. The system of claim 1, wherein the at least one processor is configured to:
allocate targeted advertising associated with the item class to the audience set during the time period.

4. The system of claim 3, wherein the targeted advertising is presented on at least one user interface associated with the audience set.

5. The system of claim 1, wherein the at least one processor is configured to:
send a response message identifying the audience set to the device.

6. The system of claim 1, wherein the statistical model was trained on training transaction data from prior to the time period and associated with the user identifiers.

7. The system of claim 6, wherein the time period is a seasonal time period and the training transaction data is of a time earlier than that of a prior occurrence of the seasonal time period.

8. The system of claim 6, wherein the time period is a non-seasonal time period and the training transaction data is of a time earlier than that of the historical transaction data.

9. The system of claim 6, wherein the time period is a non-seasonal time period and the training transaction data is of a time immediately prior to the historical transaction data.

10. A method performed by a computing device, comprising:
receiving a request identifying a time period and an item class;
retrieving, from a datastore, user identifiers based on the time period and the item class;
determining a conversion value for each of the user identifiers by applying a statistical model to historical transaction data associated with the user identifiers; and
determining an audience set comprising a subset of the user identifiers with the conversion value exceeding a threshold value.

11. The method of claim 10, wherein the datastore comprises transaction data organized by times, item classes, and the user identifiers.

12. The method of claim 10, wherein the historical transaction data is retrieved from the datastore.

13. The method of claim 10, wherein the request identifies an additional time period and an additional item class, and wherein the computing device is configured to retrieve, from the datastore, the user identifiers based on the both the time period and the additional time period, and both the item class and the additional item class.

14. The method of claim 10, wherein the threshold value is within a value range.

15. The method of claim 10, wherein the conversion value reflects how likely an associated user identifier will be associated with a purchase transaction of a product in the item class during the time period.

16. A non-transitory computer readable medium having instructions stored thereon, wherein the instructions, when executed by a processor, cause a device to perform operations comprising:
identifying a time period and an item class;
retrieving, from a datastore, user identifiers based on the time period and the item class;
determining a conversion value for each of the user identifiers by applying a statistical model to historical transaction data associated with the user identifiers; and
determining an audience set comprising a subset of the user identifiers with the conversion value exceeding a threshold value.

17. The non-transitory computer readable medium of claim 16, wherein the user identifiers are associated with individual users that are associated with an item transaction.

18. The non-transitory computer readable medium of claim 16, wherein the statistical model expresses a logistic regression.

19. The non-transitory computer readable medium of claim 16, wherein the statistical model is trained using either supervised learning, unsupervised learning, or reinforcement learning.

20. The non-transitory computer readable medium of claim 16, wherein the time period and the item class are received over a network.
